(19) United States
(12) Patent Application Publication
(10) Pub. No.: US 2013/0013386 A1
(43) Pub. Date: Jan. 10, 2013

(54) SYSTEM AND METHOD FOR ALLOCATING VALUE TO A CUSTOMER ACCOUNT

(75) Inventors: Erwin Louis BLOMEYER, Somerset West (ZA); Adriaan Jordaan ROSSOUW, Somerset West (ZA)

(73) Assignee: MOBILE POTENTIAL (PTY) LTD, Somerset West (ZA)

(21) Appl. No.: 13/215,698

(22) Filed: Aug. 23, 2011

(30) Foreign Application Priority Data
Jul. 8, 2011 (ZA) 2011/05074

(51) Int. Cl. G06Q 30/00; G06Q 20/00

(52) U.S. Cl. 705/14.27; 705/16

(57) ABSTRACT

A method and system and for allocating value such as prepaid airtime to a customer account with a service provider is provided. The method includes receiving from a point of sale a request to allocate a specific amount of airtime to the customer account, receiving a retailer identifier which identifies a retailer to which the point of sale belongs, requesting the service provider to allocate the airtime to the customer account, sending the retailer identifier to the service provider so that the service provider can bill the retailer for the allocation of airtime, obtaining a confirmation from the service provider as to whether the allocation of airtime to the customer account was successful or not and, in response to a positive confirmation that the allocation of airtime was successful, communicating the positive confirmation to the point of sale so that the allocation of airtime is charged to a customer at the point of sale and, in response to a negative confirmation that the allocation of value was not successful, communicating the negative confirmation to the point of sale so the allocation of airtime is not charged to the customer at the point of sale. The point of sale can be configured to offer the customer a choice as to whether the customer would like change for a purchase in cash or in the form of airtime, and if the customer elects to receive change in the form of airtime, the airtime to be allocated to the customer account is selected to be greater than the value of the change in cash, thereby providing the customer with a monetary incentive to choose to receive the change in the form of airtime.

### FIELD OF THE INVENTION

This invention relates to a system and a method for allocating value to a customer account and, more specifically, to a system and a method for allocating value to a customer account with a service provider.

### BACKGROUND TO THE INVENTION

Wireless network customer accounts, such as mobile phone or data accounts, are generally either prepaid or post-paid. Post-paid accounts are typically linked to contracts of a minimum duration and require subscribers to be vetted and their creditworthiness approved before such accounts are created by network providers. Prepaid accounts operate on a declining balance and, as such, are generally issued without any approval or vetting being required.

Many users prefer prepaid accounts as there is no tie-in for a contract duration and money spent can be easily monitored. Often, new entrants to the mobile market do not have credit histories or qualify for post-paid contracts, and many other users simply prefer the control that prepaid accounts offer. The use of prepaid accounts is accordingly increasing significantly in many markets. Prepaid accounts are also used for other devices, utilities and systems such as prepaid electricity meters.

One of the drawbacks of prepaid accounts is that they need to be periodically topped up or replenished or they become depleted and the associated services stopped. Most prepaid users top up their accounts by purchasing value tokens from a vendor, where each value token represents a predetermined amount or quantity of such service. These value tokens are typically in the form of an alphanumeric code that is revealed once purchased and must then be communicated to the network prepaid platform either by entering the code on a mobile phone (or other device) by the user, or by calling in the code to an Interactive Voice Response (IVR) system, or by inputting the code into a web application, so as to credit the prepaid account associated with that device.

These value tokens may be sold in various forms. In one form, value tokens are sold as so called “scratch cards”, in which the value token is printed on a card and initially obscured by a tamper-evident cover or foil which can then be obliterated by a user that has purchased the card to reveal the underlying value token. Another popular means of vending value tokens is using dedicated equipment for printing a voucher on which the value token is displayed, and then selling the voucher over the counter to a user. Typically such equipment is able to communicate with a network service provider through a secure communication channel to obtain the value token which is then printed out only after actual payment has been made by a user.

Existing methods of vending value tokens suffer from the disadvantage that value tokens, once generated, carry inherent risks in their transportation, storage and handling and are consequently a target for theft. In the case of prepaid mobile phone accounts, the value token is typically entered into the phone by typing in a USSD (Unstructured Supplementary Services Data) string (e.g. *100# followed by the value token). Anyone with access to a value token can therefore use it. If a thief is able to obtain the value token before the legitimate purchaser enters it, the thief can redeem the value onto his mobile phone account and the token will be useless when the legitimate purchaser tries to use it. If the legitimate purchaser loses the slip of paper on which the value token is printed, then the corresponding value may also be lost or used by others. Network providers and retailers typically do not track the status of each code issued and it therefore becomes extremely difficult to determine who fraudulently used a value token, leading to large write-offs by network providers and retailers as a result of lost or stolen value tokens.

Another disadvantage of existing methods of vending value tokens is that retailers generally have to pre-purchase large numbers of value tokens to be able to sell them, so that the tokens form stock which has to be carried and which may negatively affect a retailer's cash flow.

Some users may also experience difficulty in entering long value tokens onto mobile phones, such as those with poor eyesight or rheumatism, the elderly, the illiterate or the very young. In addition, existing value tokens are generally only issued for discrete and specific monetary values. If a customer has less money available than the lowest value token they are not able to purchase any token at all, and if a customer has just slightly less money available than the next highest token value they are only able to buy a lesser value token.

### OBJECT OF THE INVENTION

It is an object of this invention to provide a system and a method for allocating value to a customer account with a service provider which, at least to some extent, alleviates some of the drawbacks mentioned above.

In this specification the term “airtime” shall mean any amount or quantity of value which can be allocated to a mobile phone or data account so as to enable a customer to use services associated with the mobile phone or data account.

### SUMMARY OF THE INVENTION

In accordance with the invention there is provided a method for allocating value to a customer account with a service provider comprising, at a remotely accessible transaction server:
receiving from a point of sale a request to allocate a specific value to the customer account with the service provider, the customer account being identified either by means of receiving an account number of the customer account from the point of sale, or by means of receiving a customer identifier where the customer identifier has previously been associated with the account number of the customer account by the transaction server;
receiving from the point of sale a retailer identifier which identifies the retailer to which the point of sale belongs;
requesting the service provider to allocate the value to the customer account;
sending the retailer identifier to the service provider so that the service provider can bill the retailer for the allocation of value;
obtaining a confirmation from the service provider as to whether the allocation of value to the customer account was successful or not;
in response to a positive confirmation that the allocation of value was successful, communicating the positive confirmation to the point of sale so that the allocation of value is charged to a customer at the point of sale; and
in response to a negative confirmation that the allocation of value was not successful, communicating the negative confirmation to the point of sale so the allocation of value is not charged to the customer at the point of sale.

Further features of the invention provide for the customer to have a retailer loyalty token, such as a retailer loyalty card, which has the customer identifier stored thereon. In a preferred embodiment, during a registration for the loyalty card the customer provides the account number of the customer account and the account number is stored on a customer database. The customer database may be maintained by the retailer, in which case the account number of the customer account must be sent by the point of sale to the transaction server, but in a preferred embodiment the customer database is maintained by the transaction server, so that the transaction server only requires the customer identifier to be sent by the point of sale and obtains the customer account number by querying the customer database.

In one embodiment of the invention, the requested value allocation is a monetary value and is determined by a request made by a customer who is transacting at the point of sale. In a different embodiment, the point of sale may be configured to offer the customer a choice as to whether the customer would like change for a purchase in cash or change in the form of the value to be allocated to the customer account. The value to be allocated to the customer account may have a monetary value that is greater than the amount of change in cash, thereby providing the customer with a monetary incentive to choose to receive the change in the form of the value to be allocated to the customer account. In a yet further embodiment, the value to be allocated is determined as the difference between a value of goods or services purchased by the customer at the point of sale and a larger, whole number, where the difference has been rounded up to a larger amount so as to provide the customer with a monetary incentive to choose to receive the allocation of value.

Further features of the invention provide for the customer account to be a wireless prepaid mobile phone or data account and for the service provider to be a mobile phone network operator; and for the customer account number to be a code such as an MSISDN which uniquely identifies the customer's mobile phone or data account. The service provider may also send a separate independent confirmation of the success or otherwise of the allocation of value to a mobile phone of the customer which is associated with the customer account.

The invention extends to a system for allocating value to a customer account with a service provider comprising a remotely accessible transaction server, a number of points of sale and at least one service provider, wherein
the transaction server is able to communicate with the points of sale and with the service provider;
the point of sale is configured to request the transaction server to allocate a specific value to the customer account with the service provider, the customer account being identified at the transaction server either by means of the point of sale sending an account number of the customer account to the transaction server, or by means of the point of sale sending a customer identifier to the transaction server where the customer identifier has previously been associated with the account number of the customer account by the transaction server;
the point of sale is configured to send a retailer identifier to the transaction server which identifies the retailer to which the point of sale belongs;
the transaction server is configured to send the retailer identifier to the service provider and to request the service provider to allocate the value to the customer account;
the service provider is configured to allocate the value to the customer account and to bill the retailer for the allocation of value; and
the service provider is configured to send a confirmation to the transaction server as to whether the allocation of value to the customer account was successful or not; and
the transaction server is operable to:
   in response to a positive confirmation from the service provider that the allocation of value was successful, communicate the positive confirmation to the point of sale so that the point of sale can charge the customer for the allocation of value and,
   in response to a negative confirmation from the service provider that the allocation of value was not successful, communicate the negative confirmation to the point of sale so the point of sale does not charge the customer for the allocation of value.

The invention further extends to a loyalty token system in which a plurality of customers are provided with loyalty tokens, each loyalty token having a customer identifier stored thereon and a service provider account associated therewith, wherein a customer is able to allocate a value to the service provider account by presenting the loyalty token at a point of sale or other terminal at which the loyalty token is accepted, the point of sale or terminal being operable to communicate with a transaction server by sending the customer identifier to the transaction server and requesting that the value be allocated to the service provider account, the transaction server being operable to request that the service provider allocate the value to the customer account, and the transaction server being operable to obtain confirmation from the service provider of the outcome of the allocation of value and communicate the outcome to the point of sale or other terminal.

Further features of the invention provide for the loyalty token system to include user loyalty points which are accrued by purchases made by the customer at a retailer, and for the loyalty points to be converted into value allocated to the customer account at the point of sale or terminal at which the loyalty token is accepted.

The invention yet further extends to a method of crediting a service provider account balance at a point of sale, comprising:
providing a customer of a retailer with a retailer loyalty token, the loyalty token having a customer identifier stored thereon and a having a linked service provider account number stored on a customer database maintained at a remotely accessible transaction server;
at a point of sale at which the customer has presented the loyalty token, presenting the customer with an option to credit the service provider account balance;
in response to the customer electing to credit the service provider account balance, instructing the transaction server to credit the service provider account balance, the transaction server being configured to:
   use the customer identifier and linked service provider account number to request a crediting of the account balance from the service provider;
   obtain a confirmation from the service provider as to whether the crediting of the account balance was successful or not;
   in response to a positive confirmation that the crediting of the account balance was successful, communicating the positive confirmation to the point of sale so that the allocation of value is charged to the customer at the point of sale; and
   in response to a negative confirmation that the crediting of the account balance was not successful, communicating the negative confirmation to the point of sale so the allocation of value is not charged to the customer at the point of sale.

### BRIEF DESCRIPTION OF THE DRAWINGS

In the drawings:—

FIG. 1 is a schematic illustration of a system for allocating value to a customer account with a service provider according to the invention; and

FIG. 2 is a flow diagram showing the steps of a method according to one embodiment of the invention.

### DETAILED DESCRIPTION WITH REFERENCE TO THE DRAWINGS

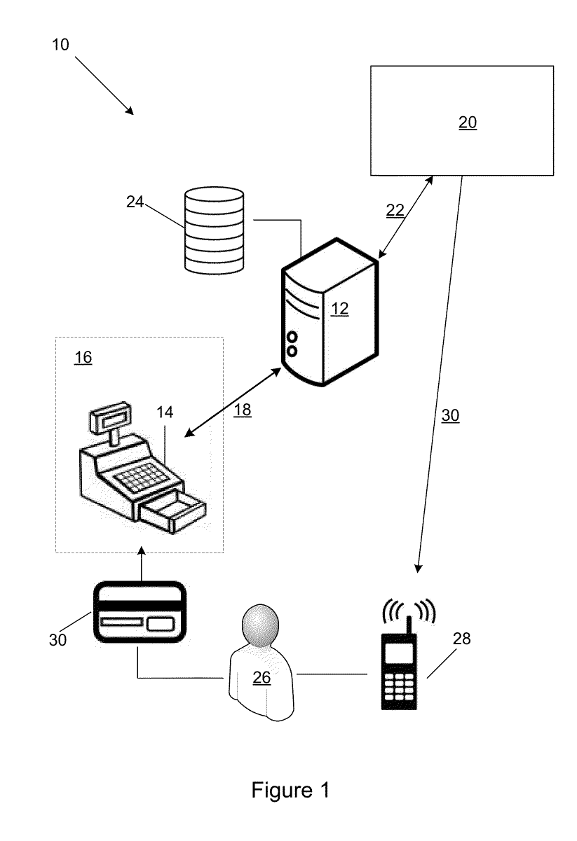

FIG. 1 shows a system (10) for allocating value to a customer account according to the invention. The system includes a remotely accessible transaction server (12) that is able to communication with a point of sale (14) at a retailer (16). While only one retailer and one point of sale are shown in this illustration, it will be appreciated that in reality the transaction server will communicate with a multitude of points of sale and retailers, each point of sale being associated with one retailer, but where retailers may each have many points of sale. The retailer may be a merchant with physical stores, in which case the point of sale may be a payment checkout machine, or the retailer may be an online retailer in which case the point of sale may be an internet portal accessible by means of a website.

Communication between the transaction server and the point of sale occurs by means of a first communications link (18) which may be a wired or wireless link and is preferably an encrypted synchronous communications link. The transaction server is also operable to communicate with at least one service provider (20), which is typically a mobile phone network operator, by means of a second communications link (22). The transaction server typically communicates directly with a secure prepaid front-end system of a mobile phone network operator service control point (also referred to as an IN or “intelligent network”), which forms the core, secure prepaid billing system of the mobile phone network. The transaction server operates as a switch in that it is able to synchronously communicate with more than one service provider (20), automatically routing communication from the point of sale (14) to the correct service provider.

A plurality of customers (26), only one of which is shown, each have customer accounts with the service provider (20). Each customer account is preferably a prepaid mobile phone or data account, and is identified by means of a unique MSISDN or cell phone number that is associated with a unique Subscriber Identity Module (SIM) card. The customer uses the SIM card to access mobile voice and data services using, for example, a mobile phone (28). Because the account is prepaid, the account must be topped up or replenished once depleted for the user to be able to continue using or accessing the mobile voice or data services on the mobile phone.

In one embodiment of the invention, the customer registers for a retailer loyalty program and receives a retailer loyalty token in the form of a retailer loyalty card (30). The retailer loyalty card is typically a plastic card that may have a bar code, magnetic stripe, electronic chip or RFID tag placed thereon which stores a unique customer identifier. During registration for the loyalty card, the customer provides the retailer with an account number for the customer account with the service provider, for example, the customer's mobile phone number (MSISDN). The customer identifiers and account numbers are then linked and stored on a customer database (24), which in some embodiments could be a database maintained locally by the retailer, but which in this embodiment is a database maintained by the transaction server (12). Customer identifiers and cell phone numbers can be obtained and linked in various ways, for example by filling in an application form and relying on data capturers to input the information, by entering the cell phone number during a point of sale registration during which one-time PIN numbers could be sent to the cell phone to confirm that the number was correctly entered, or independently by the customer entering a USSD string—e.g. *120*[loyalty card number][cell no], or online by means of a website. It will be appreciated that such linking only needs to occur once. In some embodiments, the loyalty card can be packaged by the retailer together with prepaid starter packs sold in the store, the loyalty card thereby being pre-linked to a particular cell phone account number. It is also possible for the linking of the customer identifiers and account numbers to done by the customer with the transaction server directly, so that the retailer does not even have knowledge of the customer account number. Alternatively, the retailer could supply the customer account numbers and identifiers to the transaction server for storage on the customer database.

In a physical store, the customer (26) hands the loyalty card (30) to a cashier who scans the card at the point of sale (14). The cashier asks the customer whether they wish to allocate value to the customer account linked to the loyalty card (e.g. the linked prepaid cell phone account). It is envisaged that more than one customer account may be linked to the loyalty card, in which case the cashier may enquire which account the customer wishes to allocate value to. If the customer wishes to allocate value to a customer account, the point of sale communicates the request to the transaction server. In this embodiment, at a minimum the point of sale only needs to communicate to the transaction server a retailer identifier (not shown) which identifies the retailer (16) to which the point of sale belongs, the customer identifier and the requested value allocation. Using the customer identifier, the transaction server then looks up the account number of the customer account on the customer database (24), and communicates the customer account number, retailer identifier and requested value allocation to the correctly identified service provider (20) by means of the second communications link (22). The service provider then attempts to credit the customer account with the value allocation and uses the retailer identifier to record which retailer must be billed for the allocation of value. If the customer account is successfully credited, a confirmation message is sent by the service provider to the transaction server, and the transaction server synchronously communicates the positive confirmation to the point of sale so that the allocation of value can be charged for by the point of sale. If, however, the customer account is not able to be credited (for example if the customer account has been suspended or closed) a negative confirmation that the transaction was not successful is sent by the service provider to the transaction server, and the transaction server synchronously communicates the negative confirmation to the point of sale so that the allocation of value is not charged for by the point of sale. The service provider may also return a confirmation message, such as an SMS or USSD message, to the mobile phone (28) of the customer as indicated by the arrow (30). This message provides independent confirmation to the customer that the account balance has been successfully credited.

It will be appreciated that, in an embodiment where the customer database is maintained locally by the retailer, then at a minimum the point of sale needs to communicate to the transaction server the retailer identifier, the requested value allocation and the account number of the customer account with the service provider (e.g. the customer cell phone number). An advantage, however, of having the customer database maintained by the transaction server and not having the point of sale send the customer number to the transaction server, is that the loyalty card does not need to store the customer account number, so that if the loyalty card is stolen or duplicated, an unauthorised person will not obtain access to the account number and/or there is less lag time in the event that the retailer must look up the customer number every time the loyalty card is presented at the point of sale.

The allocation of value to the customer account linked to the loyalty card can be done in various ways. In one embodiment, the amount of the requested value allocation is determined by a customer who is transacting at the point of sale. For example, the customer requests the cashier at the point of sale to add a specific monetary value to the prepaid mobile phone account linked to the loyalty card. In a different embodiment, the point of sale may be configured to offer a customer a choice as to whether the customer would like change in cash or change in the form of the value to be allocated to the customer account. The value to be allocated to the customer account may have a monetary value that is greater than the amount of change in cash, thereby providing the customer with a monetary incentive to choose to receive the change in the form of the value to be allocated to the customer account. For example, the point of sale may prompt the client, “Would you like $10.86 in change or $11 in airtime?”. In this embodiment, it is an advantage of the invention that the customer account can be credited with any denomination (e.g. any whole number) of monetary value, and not just specific pre-defined denominations (e.g. $19, $29, $59 etc). Typically, rules would be established and agreed between the retailer, transaction server and service provider as to how rewards may be calculated and offered to customers. A rule could, for example, be that for any transactions over $10, change may be offered in the form of airtime by rounding up to the nearest dollar. Such an “airtime-for-change” system also offers the benefit that customers do not have to receive a handful of coins or notes as change.

In online embodiments in which the customer transacts with a point of sale that is an internet portal accessible by means of a website, instead of offering the customer change in cash, the value to be allocated can be determined as the difference between the value of goods or services to be purchased by the customer at the point of sale and a larger, whole number amount, where the difference has been rounded up so as to provide the customer with a monetary incentive to receive the allocation of value. For example, a customer who makes $12.85 in online purchases can be offered $8 of airtime for a total of $20, so that the client is able to purchase $8 of airtime for $7.15. Again, rules would be established and agreed between the retailer, transaction server and service provider as to how such rewards may be calculated and offered to clients.

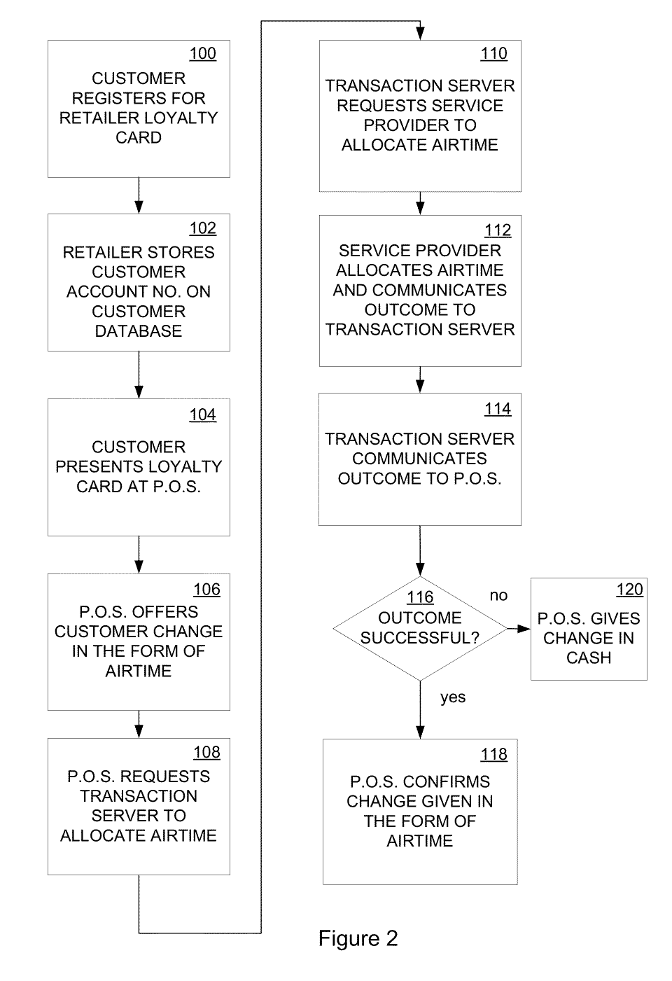

FIG. 2 shows a flow diagram that illustrates a method according to one of the preferred embodiments described. At a first stage (100), a customer registers for a retailer loyalty card. During the registration process, the customer provides an account number for the customer account with the service provider, such as the customer's mobile phone number (MSISDN). At a next stage (102), the retailer stores this customer account number on the customer database, which is preferably maintained by a transaction server. Within the customer database, the customer account number is linked to a customer identifier stored on the loyalty card.

At a next stage (104), the customer presents the loyalty card at a point of sale and the loyalty card is input or scanned at the point of sale. In the case of a physical store, the loyalty card can be presented to a cashier who scans the loyalty card to read its customer identifier, whereas in the case of a virtual store such as an internet website, the customer identifier could be input directly into the website.

At a next stage (106), and typically after all in-store purchases made by the customer have been rung up at the point of sale, the customer is offered change in the form of airtime as previously described. In the event that the customer agrees to receive change in the form of airtime, the point of sale communicates with the transaction server at stage (108) to request that the airtime be allocated. Typically, the point of sale transmits the customer identifier to the transaction server, and the transaction server looks up the customer account number on the customer database. The transaction server is also able to correctly identify the service provider associated with the customer account number and, at stage (110), communicates with the service provider to request it to allocate airtime to the customer account. The transaction server also communicates a retailer identifier to the service provider so that the service provider can identify the retailer to which the point of sale belongs and bill that retailer directly. The service provider then processes the request and communicates the outcome to the transaction server at stage (112). The transaction server then communicates the outcome of the transaction to the point of sale at stage (114). If the outcome of the allocation of airtime was successful (as illustrated by stage (116)), then the point of sale confirms to the customer that the change has correctly been given in the form of airtime, as shown at stage (118). If, however, the outcome of the allocation of airtime was not successful at stage (116), then the point of sale informs the customer that the change could not be given in the form of airtime, and change is instead given in the form of cash.

It will be appreciated that the process of allocating value to the customer account according to the illustrated embodiments of the invention is done without the customer having to enter any value tokens into a cell phone and without the risk of loss or theft of value tokens. An unauthorized person who obtains a customer's loyalty card is only able to credit the authorized customer's prepaid cell phone account with the loyalty card—the loyalty card is therefore not a target for theft. From the retailer's perspective, the system of the invention offers the advantage of building customer loyalty, since it is convenient for a customer to credit their mobile phone accounts at the retailer and they may obtain a reward from the retailer for doing so. The retailer does not have to carry stock or manage physical vouchers, and only gets billed after an allocation of value has occurred, thereby removing prepaid vouchers from the retailer balance sheet and improving retailer cash flow.

A further benefit of the invention is that end-to-end tracking of each allocation of value is facilitated by the transaction server, removing the problem of the traceability of value tokens. If an allocation of value is disputed by a customer or by a service provider, the transaction server is able to track exactly at which point of sale the allocation of value occurred, which customer account was credited and the time of allocation of value, to enable the retailer and the service provider to reconcile their records. A web portal could be provided through which each transaction can be interrogated by the retailer, and it is envisaged that the transaction server will provide daily reconciliation reports to the retailer and the service provider.

A yet further benefit of the invention is that the full value of available in-pocket money of a customer can be captured by a retailer, since the value allocation can be of variable rather than fixed denominations.

While the invention has thus far been described in relation to customers transacting at a point of sale, in other embodiments the allocation of value could happen at a terminal or access point other than a point of sale, such as an in-store kiosk at which a loyalty card is accepted. Instead of a user selecting a value to be allocated and paying for that value in cash, the user could convert previously accrued loyalty points into the value allocation. For example, for every purchase that the user makes in store they could accrue loyalty points. These points could then be converted into airtime at an in-store kiosk, a website, by means of transmitting a USSD string, at regular preset intervals or by other means. The airtime could be credited to the customer account linked to the loyalty card, or alternatively could be credited to any customer account number which the customer enters at the terminal or access point. Such a loyalty token system also falls within the scope of the invention.

The invention is not limited to the described embodiments and many variations may be made which fall within the scope of the invention. For example, the invention need not be limited to prepaid customer accounts, but could also be used in relation to post-paid customer accounts, where such customers wish to purchase additional voice or data services. Indeed the customer accounts need not even be voice or data accounts, but could be any PSTN (Public Switched Telephone Network) account, or even a prepaid electricity account. Although it is preferred that the customer account number be linked to a loyalty token so that customers do not slow down points of sale by having to manually enter account numbers, embodiments exist in which no loyalty token is used and the customer simply enters the customer account number at the point of sale. The loyalty token need not be linked to a particular retailer but could be provided a third party loyalty card, such as a medical insurance loyalty card which is accepted at the specific retailer.

This application claims priority to South Africa Patent Application No. 2011/05074 filed Jul. 8, 2011 which is expressly incorporated herein by reference in its entirety.

1. A method for allocating value to a customer account with a service provider comprising, at a remotely accessible transaction server:
receiving from a point of sale a request to allocate a specific value to the customer account with the service provider, the customer account being identified either by means of receiving an account number of the customer account from the point of sale, or by means of receiving a customer identifier where the customer identifier has previously been associated with the account number of the customer account by the transaction server;
receiving from the point of sale a retailer identifier which identifies a retailer to which the point of sale belongs;
requesting the service provider to allocate the value to the customer account and sending the retailer identifier to the service provider so that the service provider can bill the retailer for the allocation of value;
obtaining a confirmation from the service provider as to whether the allocation of value to the customer account was successful or not;
in response to a positive confirmation that the allocation of value was successful, communicating the positive confirmation to the point of sale so that the allocation of value is charged to a customer at the point of sale; and
in response to a negative confirmation that the allocation of value was not successful, communicating the negative confirmation to the point of sale so the allocation of value is not charged to the customer at the point of sale.

2. The method according to claim 1 in which the customer identifier is stored on a retailer loyalty token associated with the customer.

3. The method according to claim 2 in which the retailer loyalty token is a retailer loyalty card.

4. The method according to claim 2 which includes an initial step of registering the customer for the retailer loyalty token by requesting the account number from the customer and storing the account number on a customer database in which the customer identifier and customer account number are linked.

5. The method according to claim 4 in which the customer database is maintained by the transaction server and the customer account is identified by means of receiving the customer identifier from the point of sale and obtaining the customer account number by querying the customer database.

6. The method according to claim 4 in which the customer database is maintained by the retailer and the customer account is identified by means of the retailer using the customer identifier to query the customer database and obtain the customer account number, and the retailer then sending the customer account number to the transaction server.

7. The method according to claim 1 in which the value to be allocated is a monetary value and the amount of the requested value allocation is determined by a request made by a customer who is transacting at the point of sale.

8. The method according to claim 1 in which the value to be allocated is a monetary value and the point of sale is configured to offer the customer a choice as to whether the customer would like change for a purchase in cash or in the form of the value to be allocated to the customer account.

9. The method according to claim 8 in which, if the customer elects to receive change in the form of the value to be allocated to the customer account, the specific value to be allocated to the customer account is selected to be greater than the amount of change in cash, thereby providing the customer with a monetary incentive to choose to receive the change in the form of the value to be allocated to the customer account rather than change in the form of cash.

10. The method according to claim 1 in which the value to be allocated is determined as the difference between a value of goods or services to be purchased by the customer at the point of sale and a larger, whole number, where the difference has been rounded up to a larger amount so as to provide the customer with a monetary incentive to choose to receive the allocation of value.

11. The method according to claim 1 in which the customer account is a wireless prepaid mobile phone or data account and the service provider is a mobile phone network operator, the value to be allocated is an amount of prepaid airtime, and the customer account number is an MSISDN which uniquely identifies the customer's prepaid mobile phone or data account.

12. The method according to claim 1 in which the service provider sends a separate independent confirmation of the success or otherwise of the allocation of value to a mobile phone of the customer, the mobile phone being associated with the customer account.

13. A system for allocating value to a customer account with a service provider comprising a remotely accessible transaction server, a number of points of sale and at least one service provider, wherein
the transaction server is able to communicate with the points of sale and with the service provider;
the point of sale is configured to request the transaction server to allocate a specific value to the customer account with the service provider, the customer account being identified at the transaction server either by means of the point of sale sending an account number of the customer account to the transaction server, or by means of the point of sale sending a customer identifier to the transaction server where the customer identifier has previously been associated with the account number of the customer account by the transaction server;
the point of sale is configured to send a retailer identifier to the transaction server which identifies the retailer to which the point of sale belongs;
the transaction server is configured to send the retailer identifier to the service provider and to request the service provider to allocate the value to the customer account;
the service provider is configured to allocate the value to the customer account and to bill the retailer for the allocation of value; and
the service provider is configured to send a confirmation to the transaction server as to whether the allocation of value to the customer account was successful or not; and
the transaction server is operable to:
in response to a positive confirmation from the service provider that the allocation of value was successful, communicate the positive confirmation to the point of sale so that the point of sale can charge the customer for the allocation of value and,
in response to a negative confirmation from the service provider that the allocation of value was not successful, communicate the negative confirmation to the point of sale so the point of sale does not charge the customer for the allocation of value.

14. A loyalty token system in which a plurality of customers are provided with loyalty tokens, each loyalty token having a customer identifier stored thereon and a service provider account associated therewith, wherein a customer is able to allocate a value to the service provider account by presenting the loyalty token at a point of sale or other terminal at which the loyalty token is accepted, the point of sale or terminal being operable to communicate with a transaction server by sending the customer identifier to the transaction server and requesting that the value be allocated to the service provider account, the transaction server being operable to request that the service provider allocate the value to the customer account, and the transaction server being operable to obtain confirmation from the service provider of the outcome of the allocation of value and communicate the outcome to the point of sale or other terminal.

15. A loyalty token system as claimed in claim 14 in which loyalty points are accrued by the customers making purchases at a retailer, and the loyalty points are capable of being converted into the value allocated to the customer account at the point of sale or terminal at which the loyalty token is accepted.

16. A method of crediting a service provider account balance at a point of sale, comprising:
providing a customer of a retailer with a retailer loyalty token, the loyalty token having a customer identifier stored thereon and a having a linked service provider account number stored on a customer database maintained at a remotely accessible transaction server;
at a point of sale at which the customer has presented the loyalty token, presenting the customer with an option to credit the service provider account balance;
in response to the customer electing to credit the service provider account balance, instructing the transaction server to credit the service provider account balance, the transaction server being configured to:
use the customer identifier and linked service provider account number to request a crediting of the account balance from the service provider;
obtain a confirmation from the service provider as to whether the crediting of the account balance was successful or not;
in response to a positive confirmation that the crediting of the account balance was successful, communicating the positive confirmation to the point of sale so that the allocation of value is charged to the customer at the point of sale; and
in response to a negative confirmation that the crediting of the account balance was not successful, communicating the negative confirmation to the point of sale so the allocation of value is not charged to the customer at the point of sale.
